(19) United States
(12) Patent Application Publication
(10) Pub. No.: US 2004/0250147 A1
(43) Pub. Date: Dec. 9, 2004

(54) Uninterrupted system operation

(76) Inventor: Christopher Chang, Medfield, MA (US)

Correspondence Address: FISH & RICHARDSON PC, 225 FRANKLIN ST, BOSTON, MA, 02110, US

(21) Appl. No.: 10/454,189

(22) Filed: Jun. 3, 2003

(51) Int. Cl. G06F 1/26

(52) U.S. Cl. 713/323

(57) ABSTRACT

A method can be implemented on a computer control system for entering and exiting a power-save mode. The method includes storing a first state of a system, setting up a wake-up condition for the system, reducing power of and disabling a first portion of the system, waiting for the wake-up condition to be met, restoring operation of the first portion of the system, using a value of a power-up register to determine whether to set a current state of the system to the first state of the system, and continuing a normal operation of the system

### TECHNICAL FIELD

This invention relates to uninterrupted system operation.

### BACKGROUND

There are a variety of programmable computer systems that control peripheral devices as part of a control system. Such a programmable computer system typically includes system control circuitry, memory, and input/output (I/O) ports. These programmable computer systems can be embedded in a single semiconductor chip generally known as System on a Chip (SoC). These programmable computer systems typically have command registers to keep track of the state of commands that are issued to peripheral devices and maintain the state of the peripheral devices using status registers. The control systems sometimes experience external events such as general power failure. An event such as general power failure can be detected by electronic circuitry and instructions in the programmable computer system can be designed to handle the event as long as the control system has backup power. Thus, to prepare for such events, it is often necessary to design a battery backup to avoid sudden failure of the peripheral equipment. Since batteries are only able to provide power for a limited time, these programmable computer systems are sometimes designed with a low power consumption, or power-save, mode to conserve the battery power. Other reasons for a power-save mode can include conserving power for a stand-alone battery powered device when its operation is not required.

### SUMMARY

In one aspect, the invention features a method that includes storing a first state of a system, establishing a wake-up condition for the system, reducing power consumed by and disabling a first portion of the system, waiting for the wake-up condition to be met, restoring power and functionality to the first portion of the system, and using a value of a power-up register to determine whether to set a current state of the system to the first state of the system.

Embodiments can include one or more of the following features. One feature can be continuing a normal operation of the system. Furthermore, the first state of the system can include values of command and status registers for peripheral devices connected to the system.

The system can be based on complementary metal-oxide semiconductor (CMOS) technology. Reducing power consumed by and disabling a first portion of the system can include disabling a system clock, and restoring power and functionality to the first portion of the system can include enabling the system clock. The first state of the system can include values stored in a cache memory of a Central Processing Unit (CPU) that can be contained in the SCC and values of control and status registers of the SCC. Storing the first state of the system can include writing values of the first state into a memory, the memory can include dynamic random access memory (DRAM) which can be synchronous dynamic random access memory (SDRAM). Reducing power consumed by and disabling the system can include setting the memory to a refresh only mode. Restoring power and functionality to the system can include setting the memory to a read and write mode. The first portion of the system can include the memory.

The system can be a System on a Chip (SoC) and the memory can be located on the SoC or externally to the SoC.

Establishing a wake-up condition can include programming the wake-up condition in a wake-up circuit and arming the wake-up circuit. The first portion of the system can include the SCC and the system clock. The power-up register can be a hardware register. If a value of the power-up register can be false, then set a current state of the system to the first state of the system. If a value of the power-up register can be true, then set the current state of the system to a power-up reset state and executing power-up boot instructions. When power coming to the system has an upward transition from no power to full power, set the power-up register can be set to true. The power-up register can be set to false when the system can be in normal operation after the first power upward transition and without any additional power transition from no power to full power.

In another aspect, the invention features a system that includes a first portion that includes a system control circuitry (SCC), the SCC configured to store a first state of the system, reduce the power consumed by and disable the first portion of the system. The system also includes a power-up register configured so that its value determines whether to set a current state of the system to the first state of the system. The system also includes a wake-up circuit configured to store a wake-up condition for the system, wait for the wake-up condition to be met, read the power-up register, and restore power and functionality to the first portion of the system.

Embodiments can include one or more of the following features. The wake-up circuit can be further configured to enable the system to continue normal operation. The first state of the system can include values of command and status registers for peripheral devices connected to the system. The system can be based on complementary metal-oxide semiconductor (CMOS) technology. The SCC can be further configured to reduce power consumed by and disable the first portion of the system by disabling a system clock. The wake-up circuit can be further configured to restore power and functionality to the first portion of the system by enabling a system clock. The SCC can include a CPU that has a cache memory. The first state of the system can include values stored in the cache memory and values of control and status registers of the SCC. The SCC can be further configured to store the first state of the system by writing values of the first state into a memory. The memory can include dynamic random access memory (DRAM). The DRAM can include synchronous dynamic random access memory (SDRAM). The SCC can be further configured to reduce power consumed by and disable the system by setting the memory to a refresh only mode. The wake-up circuit can be further configured to restore power and functionality to the system by setting the memory to a read and write mode. The first portion of the system can include the memory. The system can be a System on a Chip (SoC). The memory can be part of the SoC. The memory can be external to the SoC. The SCC can be further configured to store the wake-up condition by programming the wake-up condition in the wake-up circuit and arming the wake-up circuit. The first portion of the system can include the system clock. The power-up register can be a hardware register. The wake-up circuit can be further configured so that if a value of the power-up register can be false, then the wake-up circuit sets a current state of the system to the first state of the system. The wake-up circuit can be further configured so that if a value of the power-up register can be true, then the wake-up circuit sets the current state of the system to a power-up reset state and executing power-up boot instructions. The value of the power-up register can be set to true when power coming to the system has an upward transition from no power to full power. The value of the power-up register can be set to false when the system can be in normal operation after the upward transition and without any additional power transition from no power to full power.

These and other embodiments can have one or more of the following advantages. The recovery time from a power-save mode is faster than the recovery time from a complete system reboot after a power-down mode. This power-save entrance and exit process allows more system operation flexibility because the power-save mode may be entered in at any time. This provides the possibility for wider product applications. For example, applications of control systems that require the systems to be in a wake-up state that is exactly the same as before a sleep mode was entered. For instance, it may be desirable to have the ability to freeze the state of a control system that governs the operation of an assembly line while a problem is fixed and then restart the control system in exactly the same state again.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 shows a system for controlling peripheral devices.

FIG. 2 is a process for entering a power-save mode.

FIG. 3 is a process for leaving a power-save mode and resuming normal operations.

### DETAILED DESCRIPTION

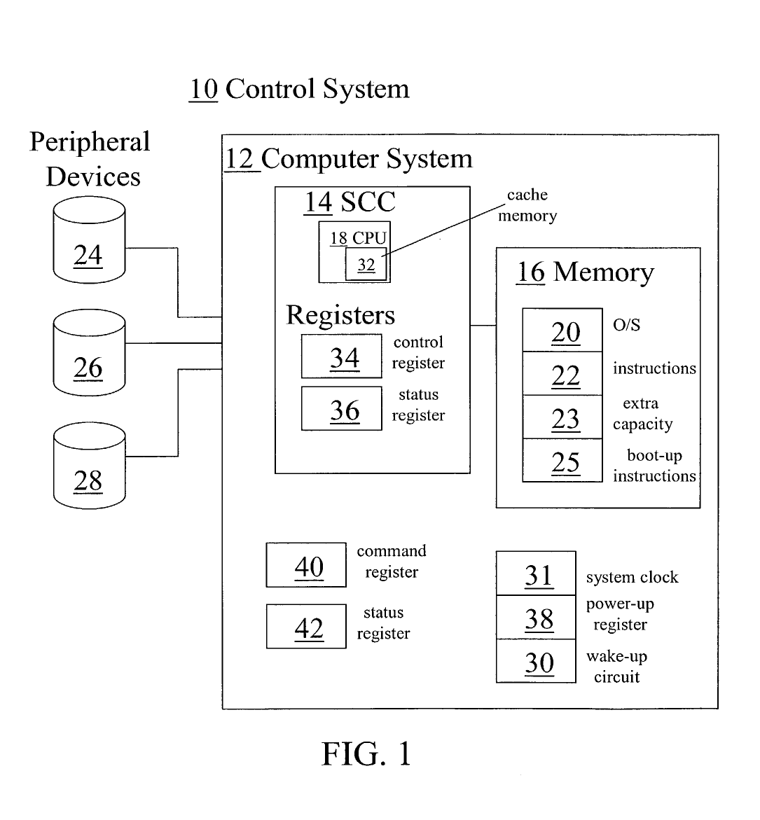

Referring to FIG. 1, control system 10 includes computer system 12 and peripheral devices 24, 26, and 28. Computer system 12 includes system control circuitry (SCC) 14 that contains CPU 18 having cache memory 32, control register 34, and status register 36. Computer system 12 also includes wake-up circuit 30 and system clock 31. System clock 31 provides timing signals to SCC 14. Computer system 12 also includes command register 40, status register 42, and hardware power-up register 38. Command register 40 holds the current state of commands to peripheral devices 24, 26, and 28, while status register 42 holds the current status of peripheral devices 24, 26, and 28. Computer system 12 also includes system memory 16. In some implementations, system 12 is contained in a single semiconductor chip, commonly known as a System on a Chip (SoC). SoC technology is the packaging of all the necessary electronic circuits and parts for a “system” (such as a cell phone or digital camera) on a single integrated circuit (IC), generally known as a microchip. For example, a SoC for a sound-detecting device might include an audio receiver, an analog-to-digital converter (ADC), a microprocessor, necessary memory, and the input/output logic control for a user - all on a single microchip. In some SoC implementations, system memory 16 is external to the SoC. System memory 16 is Dynamic Random Access Memory (DRAM). DRAM can operate in a refresh-only mode that allows memory contents retention with low power consumption. Common varieties of RAM include Synchronous DRAM (SDRAM). SCC 14 can read from and write to system memory 16. System memory 16 includes extra memory 23 and boot-up instructions 25. System memory 16 stores operating system 20 and machine-executable instructions 22 that are executed by SCC 14 to perform power save mode process 100 below. System memory 16 can be a battery backed up subsystem or a continuously powered subsystem. In this example, computer system 12 controls external peripheral devices 24, 26, and 28. Example peripheral devices include switches, electromechanical components of assembly lines for automated production, and networked home appliances. Computer system 12 can control other numbers and types of peripheral devices.

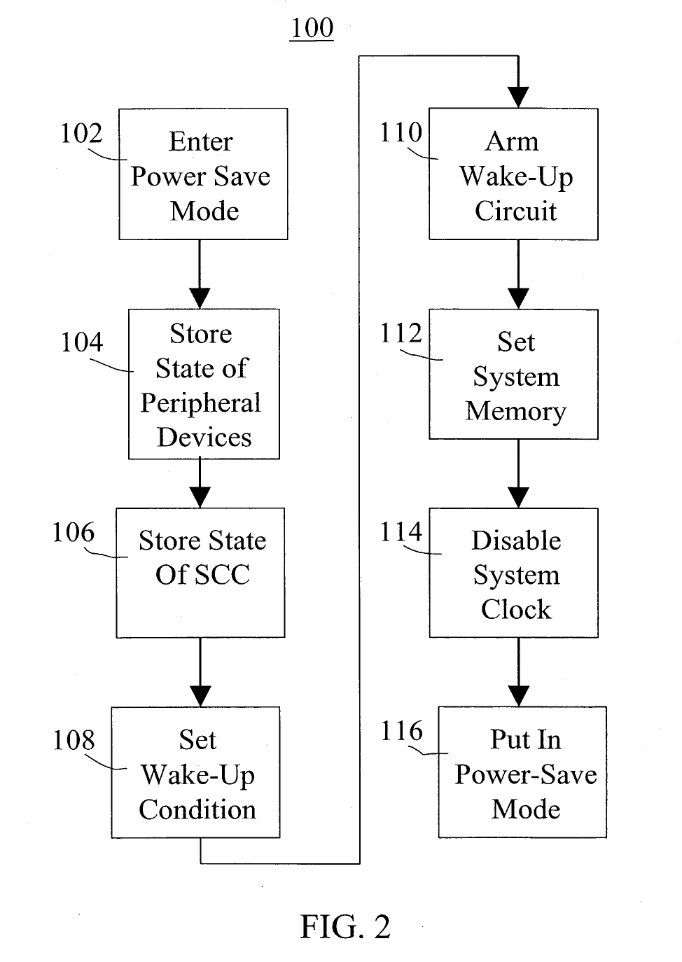

Referring to FIG. 2, power save mode process 100 enables computer system 12 to enter power-save mode under software control so computer system 12 can exit power-save mode and be restored to the exact same state from which the power-save mode was entered. In this power-save mode, system memory 16 preserves the state of computer system 12 while computer system 12 is in power-save mode. This power-save mode might be used when there is a general electrical power failure. In this case, battery backup power to computer system 12 needs to be conserved. Here, a state of computer system 12 is defined to be the values of SCC's control and status registers, cache memory 32, command register 34, and status register 36. Process 100 allows computer system 12 to enter a power-save mode without waiting for a slow response from peripheral devices 24, 26, and 28, and restores computer system 12 to the exact same state after exiting the power-save mode as it had prior to entering the power-save mode. Process 100 assumes that the states of peripheral devices 24, 26, and 28 are dependent on the states of command registers 34 and status registers 36 so that the restored states of command registers 34 and status registers 36 will be consistent with the states of peripheral devices 24, 26, and 28 after computer system 12 exits the power-save mode. SCC 14 can execute process 100 following instructions from system software 22.

Process 100 enters (102) a power-save mode. Process 100 stores (104) a state of peripheral devices controlled by computer system 12 by copying values of command register 34 and status register 36 into extra memory 23. Command register 34 holds a state of current SCC commands to peripheral devices 24, 26, 28. Status register 36 holds a state of peripheral devices 24, 26, 28. Process 100 stores (106) a state of SCC by copying values of control register 34, status register 36, and cache memory 32 into extra memory 23. Process 100 sets (108) wake-up circuitry with a condition that causes computer system 12 to exit from power-save mode. This condition is also known as a wake-up condition. In some examples, wake-up conditions include waiting a specified amount of time or waiting until an input line is set. Process 100 arms (110) wake-up circuit 30 with the wake-up condition. Process 100 sets (112) system memory 16 to refresh only mode. System memory 16, being DRAM or SDRAM, can hold the contents of its memory as long as its storage cells are refreshed or are given a new electronic charge every few milliseconds. Thus, system memory 16 can operate in a refresh-only mode that allows retention of the contents of system memory 16 with low power consumption.

Process 100 disables (114) system clock 31 to put (116) computer system 12 into the power-save mode. In some implementations where computer system 12 is based on complementary metal-oxide semiconductor (CMOS) technology, disabling system clock 31 disables and reduces the power consumption of all circuits in computer system 12 including SCC 14 that are connected to system clock 31. This disabling of system clock 31 is one implementation of the power-save mode.

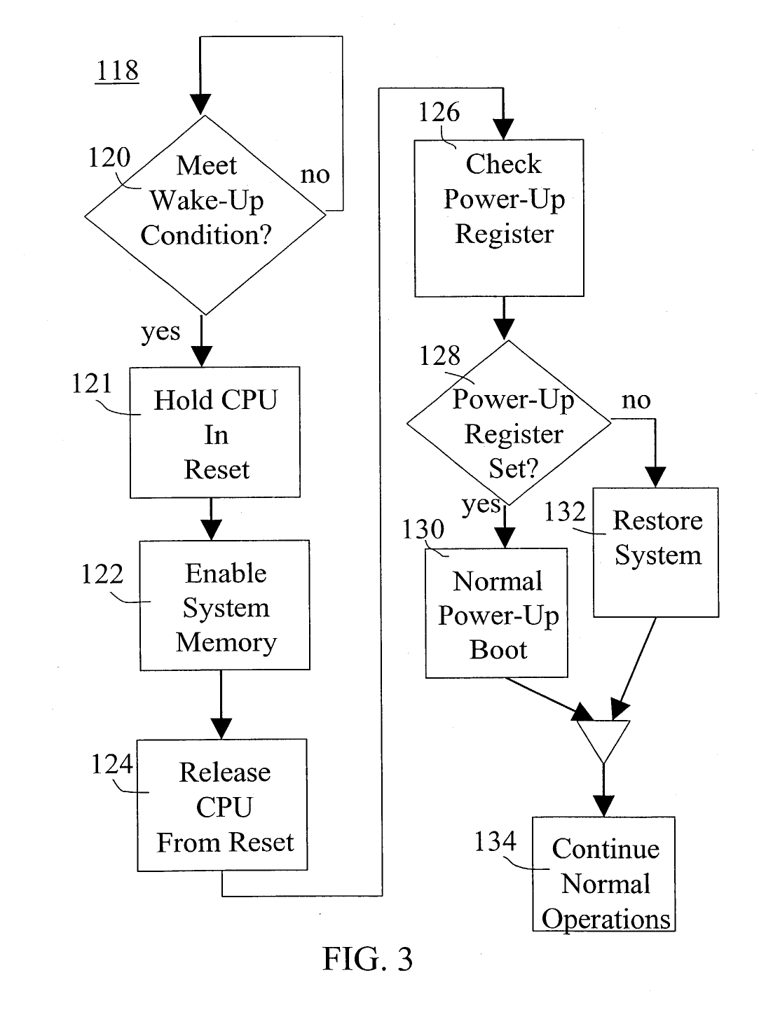

Referring to FIG. 3, system 12 exits the power-save mode and continues normal operations using process 118. Process 118 waits (120) until the wake-up condition that was set in 108 and 110 is met. In some implementations, after wake-up circuit 30 enables SCC 14, SCC 14 executes instructions from system software 22. When the wake-up condition is met, process 118 holds (121) CPU 18 in reset, enables (122) system memory by switching a mode of system memory 16 from refresh-only mode to read and write mode, and releases (124) CPU 18 from reset. Process 118 checks (126) a state of hardware power-up register 38. If the state of register 38 is true (indicating power-up), process 118 executes (130) instructions in normal power-up code. Here it should be noted that power-up register 38 is automatically set to true when the main power coming to system 12 has an upward transition, indicating a transition from a completely turned off state to a powered-on state. Subsequently, power-up boot instructions set the power-up register 38 to false. If the state of register 38 is not true (i.e., false), process 118 restores (132) the state of computer system 12 by restoring values of command register 40, status register 42, control register 34, status register 36, and memory cache 32 from the saved values in extra memory 23. Process 118 continues (134) normal operations of system 12. If computer system 12 awakens from a power-save mode, these normal operations continue from the same system state as system 12 was at before the power-save mode. In some implementations, the combination of enabling system clocks 31 and releasing SCC 14 from reset causes SCC 14 to execute code from address 0 in system memory 16. In this example, instructions to check the value of power-up register 38 are located in system memory 16 at address 0. Subsequent instructions including normal power-up boot instructions as well as instructions for exiting power-save mode for SCC 14 are located in system memory 16 at other addresses.

An example of computer system 12 is a Remote Intelligent I/O device that functions as a Programmable Logic Controller (PLC) to execute control algorithms to control peripheral devices. An interface between the controlling device and the operation under control can be any combination of GPIO (General Purpose I/O) pins. The Remote Intelligent I/O device is built into a System on a Chip (SoC). The Remote Intelligent I/O device has a built-in battery power backup so that the Remote Intelligent I/O device can save its current state in a power save mode when main power is lost. Such a device is commercially available as NET+ARM® Ethernet-ready System-on-Chip from Digi International of Minnetonka, Minn. While the Remote Intelligent I/O device is executing an algorithm to control a peripheral device, a command from network, or other ways including a hardware interrupt signal, can tell the Remote Intelligent I/O device to enter power save mode due to plant power loss or some other events. The Remote Intelligent 1/O device saves its system state as described above and enters power-save mode. Subsequently, a network command (or other hardware means) sends a RESUME command to the Remote Intelligent I/O device. Next, the Remote Intelligent I/O device wakes up, restores the computer system state, and resumes the operation. If the complete system state were not stored in memory, the device would have to restart the control algorithm from the beginning. This could potentially either cause damage because the system state of the controlling device and the state of the operation under its control do not match or it could waste precious time. This assumes that the state of the operation under the Remote Intelligent I/O device's control at the peripheral device can be continued after the power-save period because the peripheral device's state has not changed during the power-save period.

The invention can be implemented in digital electronic circuitry, or in computer hardware, firmware, software, or in combinations of them. The invention can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices, magnetic disks, e.g., internal hard disks or removable disks, magneto-optical disks, and CD-ROM and DVD-ROM disks. The processor and the memory can be supplemented by, or incorporated in special purpose logic circuitry.

A number of embodiments of the invention have been described. Nevertheless, it will be understood that various modifications may be made without departing from the spirit and scope of the invention. Accordingly, other embodiments are within the scope of the following claims.

What is claimed is:

1. A method comprising:
storing a first state of a system;
establishing a wake-up condition for the system;
reducing power consumed by and disabling a first portion of the system;
waiting for the wake-up condition to be met;
restoring power and functionality to the first portion of the system; and
using a value of a power-up register to determine whether to set a current state of the system to the first state of the system.

2. The method of claim 1 further comprising continuing a normal operation of the system.

3. The method of claim 1 wherein the first state of the system comprises values of command and status registers for peripheral devices connected to the system.

4. The method of claim 1 wherein the system comprises a system control circuitry (SCC).

5. The method of claim 4 wherein the system is based on complementary metal-oxide semiconductor (CMOS) technology.

6. The method of claim 5 wherein reducing power consumed by and disabling the first portion of the system comprises disabling a system clock.

7. The method of claim 6 wherein restoring power and functionality the system comprises enabling the system clock.

8. The method of claim 4 wherein the first state of the system comprises values stored in a cache memory of a Central Processing Unit (CPU) contained in the SCC and values of control and status registers of the SCC.

9. The method of claim 1 wherein storing the first state of the system comprises writing values of the first state into a memory.

10. The method of claim 9 wherein the memory comprises dynamic random access memory (DRAM).

11. The method of claim 10 wherein the RAM comprises synchronous dynamic random access memory (SDRAM).

12. The method of claim 10 wherein reducing power consumed by and disabling the system comprises setting the memory to a refresh only mode.

13. The method of claim 10 wherein restoring power and functionality to the system comprises setting the memory to a read and write mode.

14. The method of claim 9 wherein the first portion of the system comprises the memory.

15. The method of claim 8 wherein the system is a System on a Chip (SoC).

16. The method of claim 15 wherein the memory is part of the SoC.

17. The method of claim 15 wherein the memory is external to the SoC.

18. The method of claim 1 wherein establishing the wake-up condition comprises programming the wake-up condition in a wake-up circuit and arming the wake-up circuit.

19. The method of claim 6 wherein the first portion of the system comprises the SCC and the system clock.

20. The method of claim 1 wherein the power-up register is a hardware register.

21. The method of claim 1 further comprising, if a value of the power-up register is false, then setting a current state of the system to the first state of the system.

22. The method of claim 21 further comprising, if the value of the power-up register is true, then setting the current state of the system to a power-up reset state and executing power-up boot instructions.

23. The method of claim 21 further comprising setting the value of the power-up register to true when power coming to the system has an upward transition from no power to full power.

24. The method of claim 23 wherein the value of the power-up register is set to false when the system is in normal operation after the upward transition and without any additional power transition from no power to full power.

25. A system comprising:
a first portion comprising a system control circuitry (SCC), the SCC configured to store a first state of the system, reduce the power consumed by and disable the first portion of the system;
a power-up register configured so that its value determines whether to set a current state of the system to the first state of the system; and
a wake-up circuit configured to store a wake-up condition for the system, wait for the wake-up condition to be met, read the power-up register, and restore power and functionality to the first portion of the system.

26. The system of claim 25 wherein the wake-up circuit is further configured to enable the system to continue normal operation.

27. The system of claim 25 wherein the first state of the system comprises values of command and status registers for peripheral devices connected to the system.

28. The system of claim 25 wherein the system is based on complementary metal-oxide semiconductor (CMOS) technology.

29. The system of claim 28 wherein reducing power consumed by and disabling the first portion of the system comprises disabling a system clock.

30. The system of claim 29 wherein restoring power and functionality to the first portion of the system comprises enabling the system clock.

31. The system of claim 25 wherein the SCC comprises a CPU having a cache memory.

32. The system of claim 31 wherein the SCC further comprises control and status registers and the first state of the system comprises values stored in the cache memory and values of the control and status registers of the SCC.

33. The system of claim 25 wherein the SCC is further configured to store the first state of the system by writing values of the first state into a memory.

34. The system of claim 33 wherein the memory comprises dynamic random access memory (DRAM).

35. The system of claim 34 wherein the RAM comprises synchronous dynamic random access memory (SDRAM).

36. The system of claim 34 wherein the SCC is further configured to reduce power consumed by and disable the system by setting the memory to a refresh only mode.

37. The system of claim 34 wherein the wake-up circuit is further configured to restore power and functionality to the system by setting the memory to a read and write mode.

38. The system of claim 33 wherein the first portion of the system comprises the memory.

39. The system of claim 33 wherein the system is a System on a Chip (SoC).

40. The system of claim 39 wherein the memory is part of the SoC.

41. The system of claim 39 wherein the memory is external to the SoC.

42. The system of claim 25 wherein the SCC is further configured to store the wake-up condition by programming the wake-up condition in the wake-up circuit and arming the wake-up circuit.

43. The system of claim 29 wherein the first portion of the system comprises the system clock.

44. The system of claim 25 wherein the power-up register is a hardware register.

45. The system of claim 25 wherein the wake-up circuit is further configured so that if a value of the power-up register is false, then the wake-up circuit sets a current state of the system to the first state of the system.

46. The system of claim 45 wherein the wake-up circuit is further configured so that if the value of the power-up register is true, then the wake-up circuit sets the current state of the system to a power-up reset state and executes power-up boot instructions.

47. The system of claim 45 wherein the wake-up circuit is further configured to set the value of the power-up register to true when power coming to the system has an upward transition from no power to full power.

48. The system of claim 47 wherein the wake-up circuit is further configured to set the value of the power-up register to false when the system is in normal operation after the upward transition and without any additional power transition from no power to full power.
